(19) United States
(12) Patent Application Publication
(10) Pub. No.: US 2023/0157325 A1
(43) Pub. Date: May 25, 2023

(54) SYSTEM, METHOD, AND FORMULATION FOR AN ALL-IN-ONE COFFEE OR TEA SERVING

(71) Applicant: InstaBrew LLC, Orlando, FL (US)

(72) Inventors: Ron Montano, Orlando, FL (US); Juan M. Escobar, Orlando, FL (US); Jimmy Avendano, Orlando, FL (US)

(73) Assignee: InstaBrew LLC, Orlando, FL (US)

(21) Appl. No.: 17/991,877

(22) Filed: Nov. 22, 2022

Related U.S. Application Data
(60) Provisional application No. 63/283,223, filed on Nov. 25, 2021.

(51) Int. Cl. A23L 2/60; A23P 10/28; A23F 5/30; A23L 2/56

(52) U.S. Cl. CPC A23L 2/60; A23P 10/28; A23F 5/30; A23L 2/56

(57) ABSTRACT

An all-in-one beverage serving and a method of manufacturing the all-in-one beverage serving is described. The method includes: forming a mixture of a predetermined amount of panela, a predetermined amount of an active ingredient, optionally a predetermined amount of a functional component, and optionally a predetermined amount of a flavoring component. The method then includes placing the mixture into a mold and compressing the mixture to form a solid tablet (e.g., the all-in-one beverage serving). The solid tablet may then be placed into water or milk (or a similar beverage) to form an instant beverage for a user to enjoy.

### CROSS-REFERENCE TO RELATED APPLICATIONS SECTION

This application claims priority to U.S. Provisional Patent Application No. 63/283,223 filed on Nov. 25, 2021, which is incorporated by reference for all purposes as if fully set forth herein.

### FIELD OF THE EMBODIMENTS

The field of the invention and its embodiments relates to a system, a method, and a formulation of all-in-one coffee or tea serving.

### BACKGROUND OF THE EMBODIMENTS

Loose-leaf tea, tea bags, and instant tea powders are known in the art. Using loose-leaf tea and tea bags requires the consumer to dispose of the used tea leaves and/or the tea bag after the tea has been brewed. Further, in the standard process for brewing a cup of tea, the loose-leaf tea and tea bags are separate entities from the sugar and/or milk which are typically added to a tea-based beverage prior to consumption. Accordingly, a consumer desiring a cup of tea with sugar and milk requires that the user obtain each of these items separately, prior to making the beverage. As such, the standard process for making a cup of tea is time consuming and inconvenient.

Further, though instant coffee, or a beverage derived from brewed coffee beans that enables users to quickly prepare hot coffee by adding hot water or milk and stirring, is commonly used, it lacks flavor. As such, there has been a desire to improve these products. For example, coffee tablets or cubes are generally prepared from soluble coffee extracts. However, coffee tablets have not been commercially successful, since they are typically subject to breakage due to their fragility and also because such tablets do not possess the same degree of aroma and flavor as other forms of powdered coffee.

Therefore, a need still exists for an all-in-one coffee or tea serving that is easy to use, provides flavor, and is not subject to breakage.

### Review of Related Art

U.S. Pat. No. 3,121,635A describes a method for making readily water-soluble tablets from finely-divided, water-extracted coffee bean extract particles. The method includes: moistening a mass of substantially dry, finely-divided, water-extracted coffee extract particles with water in excess of about 0.1 wt. % based upon the weight of the extract particles to produce a mass of damp but non-cohesive particles; molding the moistened mass of particles under sufficient pressure within the range of about 25-200 pounds per square inch to cause the particles to adhere and form a coherent friable tablet; and desiccating the resultant tablet to completely remove the moisture therefrom.

US20160135476A and WO2016081512A1 describe a tea solid composition comprising a mixture of finely ground tea, a binding agent, and water. The mixture forms a tea solid composition in response to heating and subsequent cooling in a mold. The tea solid composition may further include a sweetener, a ground spice, a flavor extract, a powdered milk product, a color additive, and/or a thickener.

CA285119A describes a method of forming coffee units. The method includes: mixing roasted disintegrated coffee beans with coffee concentrate and molding the resultant product into cakes under pressure.

U.S. Pat. No. 4,031,238A describes a water-soluble solid beverage cube that includes powdered glucose monohydrate, sucrose, and a hygroscopic flavor material. This reference also describes a method to produce the water-soluble solid beverage cube that includes: mixing the ingredients; heating the ingredients above 95° F. in a high humidity atmosphere; shaping the solidified mass; and allowing the solid mass to cool.

WO2004034798A1 describes a coffee tablet that is obtainable by molding and freeze-drying a solution of coffee solids into a desired shape. The coffee tablet also has a closed surface pore structure and an internal pore structure. A majority of the pores in the pore structure are interconnected and have a size of between 5 and 50 micrometers. The coffee tablet can also include a coating of a coffee, a flavorant, a colorant, or an aroma.

US20080187628A1 describes quick-dissolve flavor tablets for use by consumers in flavoring beverages, such as water, and methods for flavoring such beverages. The tablet comprises a flavor component and a quick-dissolve carrier component that disintegrates rapidly upon placement into the beverage container with minimal residue. An example of a suitable flavoring includes a coffee flavoring.

US20100104695A1 describes a method of manufacturing a solid water-soluble tablet that includes: forming a mixture of approximately 80% to 93% by weight of Panela and about 7% to 20% by weight of an active ingredient (such as coffee, tea, or cocoa); placing the mixture into a non-stick mold; and compressing the mixture to form a solid tablet.

US20120231137A1 describes a ground roast coffee tablet.

U.S. Pat. No. 3,666,483A describes a method for preparing products of dry coffee or tea concentrate. The method includes: mixing the dry coffee or tea concentrate with at least one binder selected from the group consisting of (a) a fat which is solid or semi-solid at room temperature together with an emulsifier and (b) a fatty acid which is solid or semi-solid at room temperature together with a substance that can form a water-soluble salt with the fatty acid. The concentrate and the binder form a composition of coherent consistency, where the concentrate to the fat or fatty acid lie in the range from 2:1 to 1:3. The method also includes forming the composition into portion units.

U.S. Pat. No. 1,951,357A describes a method of forming a compressed coffee tablet, stable in the atmosphere and readily disintegrable in water. The method includes: incorporating therewith as a binder, gelatin and dextrin, and compressing the mixture to the desired form.

CA2758250C describes a ground roast coffee tablet that is capable of being brewed in a conventional automatic drip coffee maker, and which exhibits sufficient strength to withstand all aspects of manufacture, handling, packaging, transport without breakage but also readily disintegrates when contacted with hot water during brewing.

WO2020161740A2 describes a tea cube containing a blend of granular sugar, dry extract of either black or green teas, micronized tea, and flavor.

### SUMMARY OF THE EMBODIMENTS

The present invention and its embodiments relate to an all-in-one beverage serving.

In particular, a first embodiment of the present invention describes a method of manufacturing an all-in-one beverage serving. The method includes numerous process steps, such as: forming a mixture of panela and an active ingredient. In examples, the active ingredient is a beverage material, a nutritional supplement, and/or a vitamin, among others. In some examples, the beverage material may include coffee, tea, or cocoa. In other embodiments, the active ingredient is freeze-dried coffee. In some examples, the mixture further includes a functional component. The functional component may be a cannabidiol (CBD), collagen, a digestive enzyme, a protein, and a supplement, among other components.

The method also includes placing the mixture into a mold and compressing the mixture to form a solid tablet (e.g., the all-in-one beverage serving). In examples, the mixture is compressed in the mold using a mechanical action, a hydraulic action, or a pneumatic action. Further, a shape of the mold may be a circular shape, an oval shape, a rectangular shape, a square shape, a triangular shape, a quadrilateral shape, a pentagonal shape, a hexagonal shape, a heptagonal shape, an octagonal shape, a nonagonal shape, or a decagonal shape such that the mold forms the solid tablet into the shape of the mold.

A second embodiment of the present invention describe a method of manufacturing an all-in-one beverage serving. The method includes numerous process steps, such as: forming a mixture of panela, an active ingredient, and a flavoring component. In examples, the active ingredient is a beverage material. Further, the beverage material is coffee, tea, or cocoa. In other examples, the active ingredient is freeze-dried coffee. In some examples, the mixture further includes a functional component, such as: a cannabidiol (CBD), collagen, a digestive enzyme, a protein, and/or a supplement, among others. Additionally, in examples, the flavoring component is a natural flavoring component or an artificial flavoring component.

The method also includes placing the mixture into a mold and compressing the mixture to form a solid tablet. The mixture may be compressed in the mold using a mechanical action, a hydraulic action, or a pneumatic action. A shape of the mold may be a circular shape, an oval shape, a rectangular shape, a square shape, a triangular shape, a quadrilateral shape, a pentagonal shape, a hexagonal shape, a heptagonal shape, an octagonal shape, a nonagonal shape, or a decagonal shape such that the mold forms the solid tablet into the shape of the mold.

A third embodiment of the present invention describes an all-in-one beverage serving. The all-in-one beverage serving includes a predetermined amount of panela, a predetermined amount of a functional component, and a predetermined amount of an active ingredient. The functional component may be a cannabidiol (CBD), collagen, a digestive enzyme, a protein, and/or a supplement, among others. The active ingredient may be a beverage material, a nutritional supplement, or a vitamin. In examples where the active ingredient is the beverage material, the beverage material may be coffee, tea, or cocoa.

In some examples, the all-in-one beverage serving may further include a flavoring component. In examples, the flavoring component is a natural flavoring component or an artificial flavoring component.

### BRIEF DESCRIPTION OF THE DRAWINGS

FIG. 1 depicts a block diagram of components in a mixture for an all-in-one beverage serving, according to at least some embodiments disclosed herein.

FIG. 2 depicts a graph of various configurations of an all-in-one beverage serving, according to at least some embodiments disclosed herein.

FIG. 3 depicts a graph of various configurations of all-in-one beverage serving, according to at least some embodiments disclosed herein.

FIG. 4 depicts an image of a mold used to create all-in-one beverage serving, according to at least some embodiments disclosed herein.

FIG. 5 depicts an image of a mold used to create all-in-one beverage serving, according to at least some embodiments disclosed herein.

FIG. 6 depicts an image of a mold used to create all-in-one beverage serving, according to at least some embodiments disclosed herein.

FIG. 7 depicts an image of machinery used to compress a mixture in a mold to create all-in-one beverage serving, according to at least some embodiments disclosed herein.

FIG. 8 depicts an image of an-in-one beverage serving, according to at least some embodiments disclosed herein.

FIG. 9 depicts an image of an image of various all-in-one beverage servings having different components, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the term “about” is used in conjunction with a numerical range, it modifies that range by extending the boundaries above and below those numerical values. In general, the term “about” is used herein to modify a numerical value above and below the stated value by a variance of 20%, 10%, 5%, or 1%. In certain embodiments, the term “about” is used to modify a numerical value above and below the stated value by a variance of 10%. In certain embodiments, the term “about” is used to modify a numerical value above and below the stated value by a variance of 5%. In certain embodiments, the term “about” is used to modify a numerical value above and below the stated value by a variance of 1%.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

As used herein, “a formulation” may be used interchangeably with “a composition” and/or “a configuration” throughout the specification and refer to the composition as described herein. The formulation may be in a solid form. The formulation may be high in one or more components of the invention or may be in the form of a combined pack of at least two parts, each part containing the required level of one or more component.

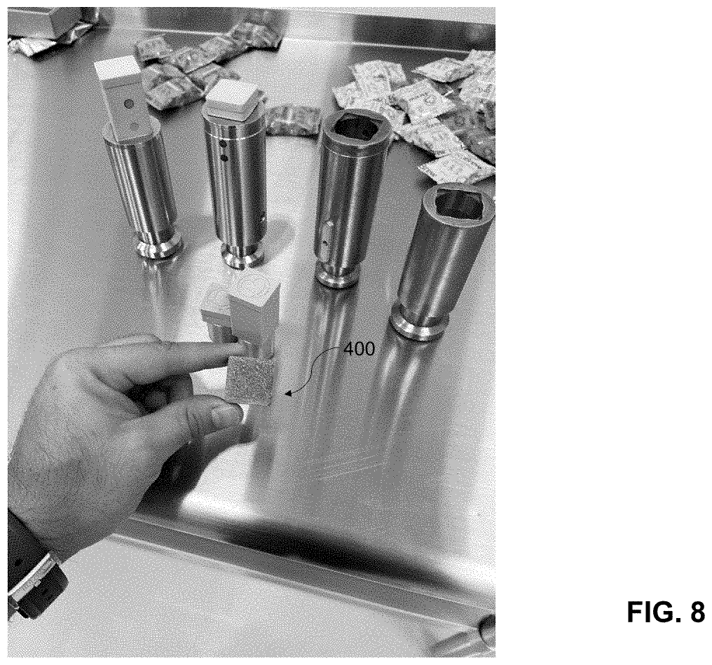

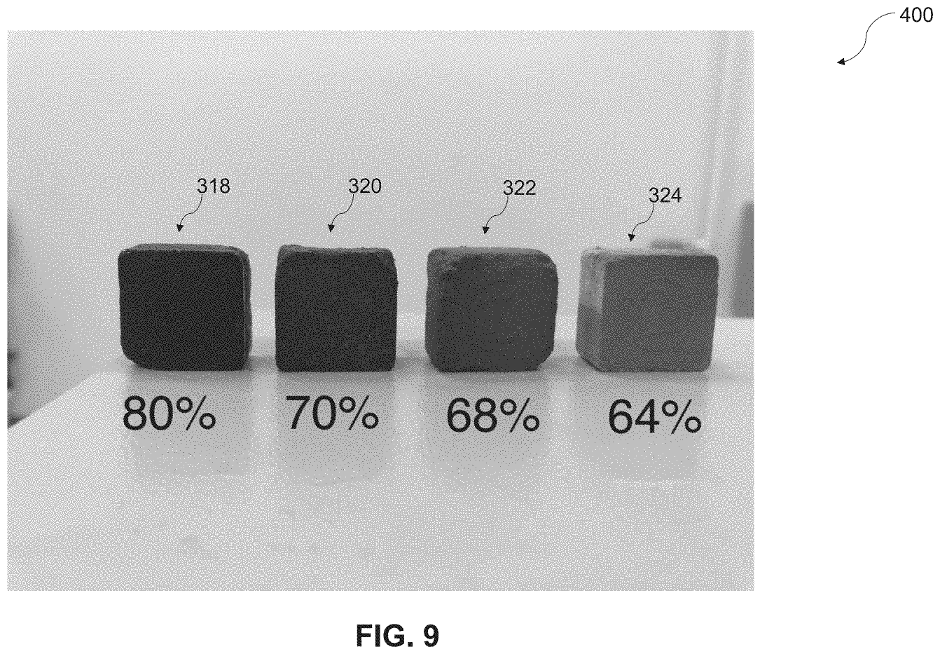

The instant invention provides an all-in-one beverage serving 400 (of FIG. 8 and FIG. 9) and methods to create the all-in-one beverage serving 400. The all-in-one beverage serving 400 is a dry-packaged and water-soluble beverage material that is dry formed into a solid tablet. The all-in-one beverage serving 400 may be dissolved directly in a beverage, such as water or milk, to produce an instant beverage, such as a unflavored coffee, a flavored coffee, or a tea product. It should be appreciated that a user may place any quantity of the all-in-one beverage servings 100 into the water or the milk to create the instant beverage.

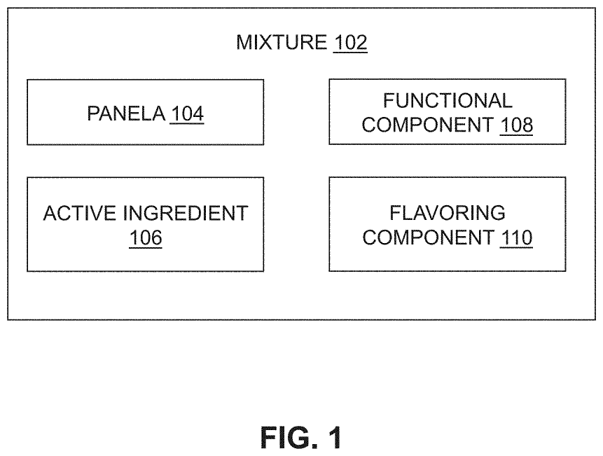

Specifically, as shown in FIG. 1, a mixture 102 used to create the all-in-one beverage serving 400 includes numerous components, such as: a predetermined amount of panela 104 and a predetermined amount of an active ingredient 106. As described herein, the panela 104 is an unrefined whole cane sugar. More specifically, the panela 104 is a solid form of sucrose derived from the boiling and evaporation of sugarcane juice. The panela 104 is sold in many forms, including liquid, granulated, and solid blocks, and is used in the canning of foods. The panela 104 is useful in the instant invention as compared to traditional sugars since the panela 104 serves as both a sweetener and a binder. Moreover, the panela 104 is low in moisture content and is highly crystallized such that it does not absorb large quantities of atmospheric moisture. Further, the active ingredient 106 may be a beverage material, a nutritional supplement, or a vitamin, among other active ingredients not explicitly listed herein. In examples where the active ingredient 106 is the beverage material, the beverage material may be coffee, tea, or cocoa, among others not explicitly listed herein. In further embodiments, the active ingredient 106 is freeze-dried coffee.

As shown in FIG. 1, the mixture 102 for the all-in-one beverage serving 400 may further optionally include a predetermined amount of a functional component 108 and/or a predetermined amount of a flavoring component 110, among other components not explicitly listed herein. In examples, the functional component 108 may be a cannabidiol (CBD) (e.g., a phytocannabinoid), collagen, a digestive enzyme, a protein, and/or a supplement, among others.

In some examples, the flavoring component 110 is a natural flavoring component or an artificial flavoring component, such as: a vanilla flavoring component, a caramel flavoring component, a hazelnut flavoring component, a citrus flavoring component, a cinnamon flavoring component, a cappuccino flavoring component, an amaretto flavoring component, a mocha flavoring component, a cocoa flavoring component, a cardamom flavoring component, a maple syrup flavoring component, a honey flavoring component, a pumpkin flavoring component, a ginger flavoring component, a blueberry flavoring component, a chai flavoring component, a chamomile flavoring component, a cranberry flavoring component, an echinacea flavoring component, an apple flavoring component, an elderberry flavoring component, a hibiscus flavoring component, a lemon flavoring component, a lemongrass flavoring component, a mango flavoring component, a mint flavoring component, an orange flavoring component, a peach flavoring component, an almond flavoring component, a pomegranate flavoring component, a berry flavoring component, a raspberry flavoring component, a strawberry flavoring component, and/or a turmeric flavoring component, among others not explicitly listed herein. It should be appreciated that the flavoring component 110 may be in a powder form or an extract form. Due to the simplicity of the materials employed in the formulation described herein, manufacturing time and costs are greatly reduced.

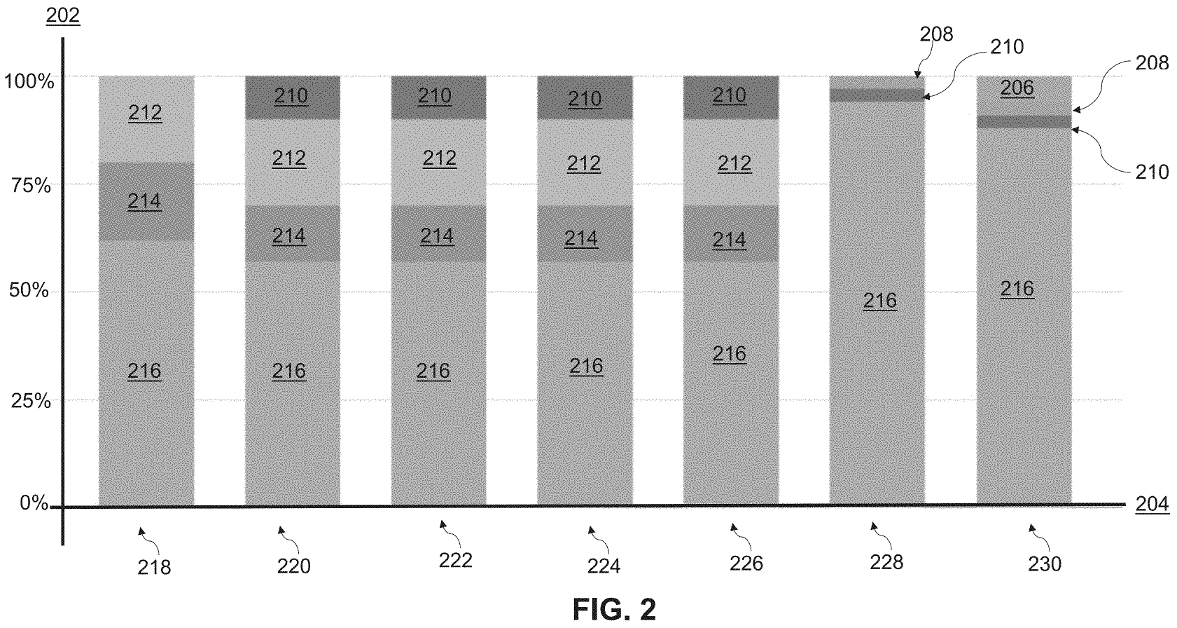

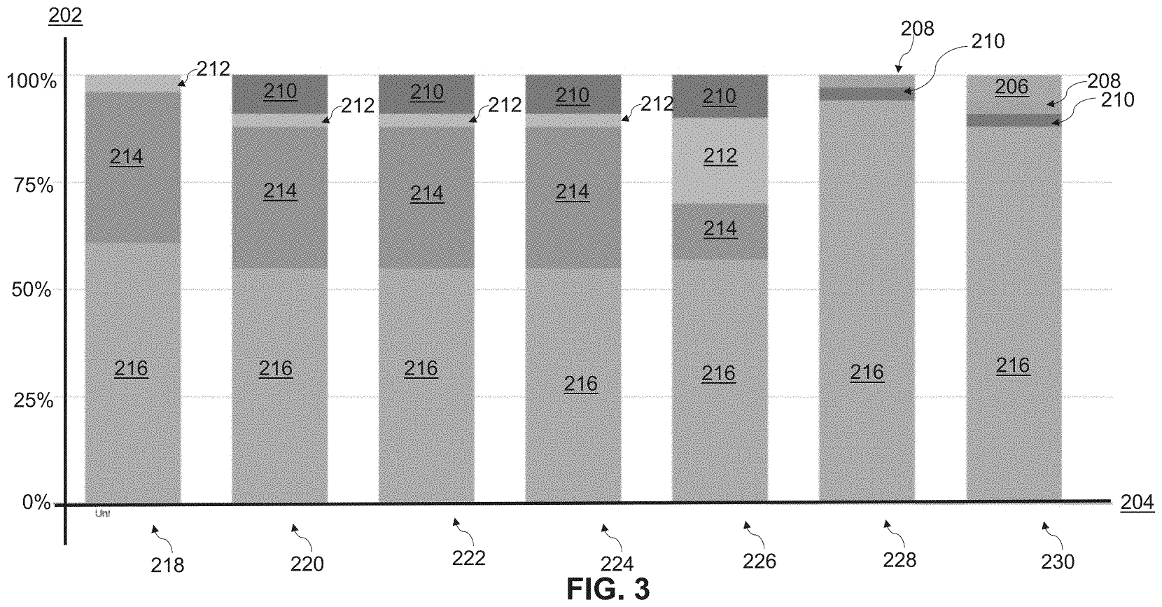

Further, both FIG. 2 and FIG. 3 depict graphs of various configurations of the all-in-one beverage serving 400. FIG. 2 and FIG. 3 each includes x-axis 204 and a y-axis 202. The x-axis 204 of FIG. 2 and FIG. 3 depicts various configurations of the all-in-one beverage serving 400. For example, the x-axis 204 of each of FIG. 2 and FIG. 3 depicts: an unflavored coffee configuration 218 of the all-in-one beverage serving 400, a caramel flavored coffee configuration 220 of the all-in-one beverage serving 400, a vanilla flavored coffee configuration 222 of the all-in-one beverage serving 400, a hazelnut coffee configuration 224 of the all-in-one beverage serving 400, a cinnamon coffee configuration 226 of the all-in-one beverage serving 400, a citron coffee configuration 228 of the all-in-one beverage serving 400, and a citron and tea configuration 230 of the all-in-one beverage serving 400.

The y-axis 204 of each of FIG. 2 and FIG. 3 depicts a percentage of each ingredient/component included within the all-in-one beverage serving 400, such as: black tea 206 (e.g., the active ingredient 106 of FIG. 1), citric acid 208 (e.g., the flavoring component 110 of FIG. 1), the flavoring component 210 (e.g., the flavoring component 110 of FIG. 1), a first coffee 212 (e.g., the active ingredient 106 of FIG. 1), a second coffee 214 (e.g., the active ingredient 106 of FIG. 1), and panela 216 (e.g., the panela 104 of FIG. 1).

As shown in FIG. 3, the usage ratios between the first coffee 212 and the second coffee 214 were inverted from FIG. 2 to maintain a volumetric mass of each component and to enhance a dilution without compromising quality and taste. Body and balance in the flavored coffees were improved in the configurations of FIG. 3 as compared to the configurations of FIG. 2. There is no change in the citron coffee configuration 228 and the citron and tea configuration 230 between the configurations of FIG. 2 and FIG. 3. With the configurations shown in FIG. 3 as compared to those of FIG. 2, the stability in weight and the caffeine content in the coffee-based products of the all-in-one beverage serving 400 is improved.

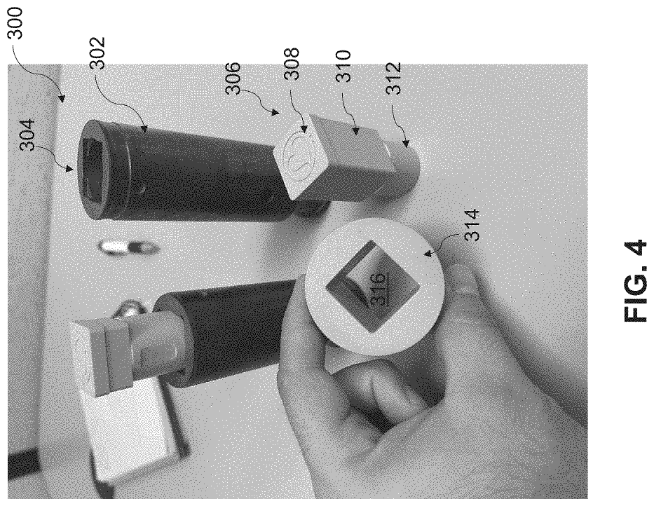

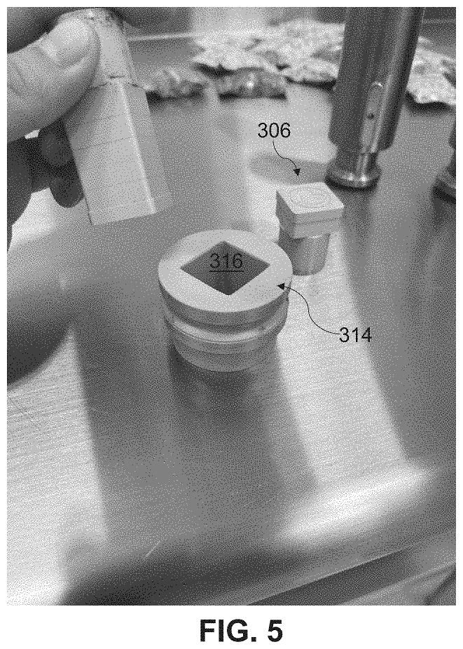

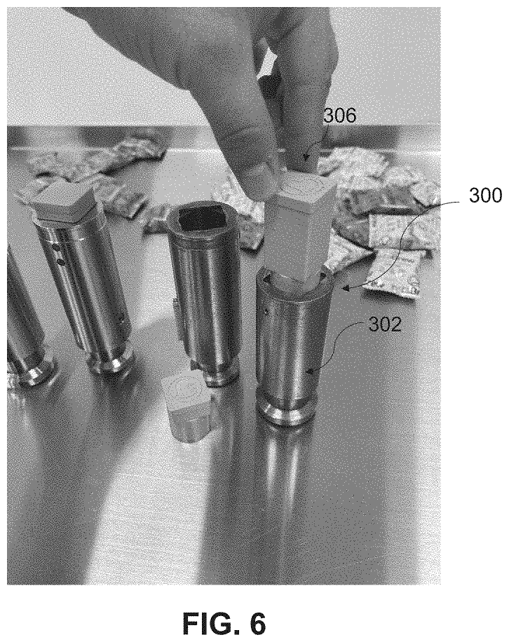

Further, as shown in FIG. 4, FIG. 5, and FIG. 6, a mold 300 may be used to create the all-in-one beverage serving 400. In general, the mold 300 includes a cylindrical body 302 with a hollow interior 304. The hollow interior 304 of the mold 300 is configured to receive a first component 306. The first component 306 includes a body portion 310 disposed between a first end 308 and a second end 312.

The first end 308 of the first component 306 has a diameter larger than the second end 312 of the first component 306. In fact, a shape of the first end 308 of the first component 306 differs from a shape of the second end 312 of the first component 306. As shown in FIG. 4, the shape of the first end 308 of the first component 306 is a square shape and a the shape of the second end 312 of the first component 306 is a cylindrical shape. However, it should be appreciated that these shapes are being provided for illustrative purposes only and other shapes are contemplated. The second end 312 of the first component 306 is configured to receive a second component 314. The second component 314 includes an opening 316 disposed therewith. A shape of the opening 316 is identical to the hollow interior 304 of the mold 300.

In examples, the shape of the hollow interior 304 of the mold 300 is a circular shape, an oval shape, a rectangular shape, a square shape, a triangular shape, a quadrilateral shape, a pentagonal shape, a hexagonal shape, a heptagonal shape, an octagonal shape, a nonagonal shape, or a decagonal shape such that the mold 300 forms the solid tablet (e.g., the all-in-one beverage serving 400) into the shape of the mold 300.

The mold 300 is made of one or more materials having thermoplastic properties. It should be appreciated that in examples, polyether ether ketone (or PEEK) may be used herein to shape the granulated panela 104 and other consumables into cubes and other shapes. As described herein, PEEK is a colorless organic thermoplastic polymer in the polyaryletherketone (PAEK) family, used in engineering applications.

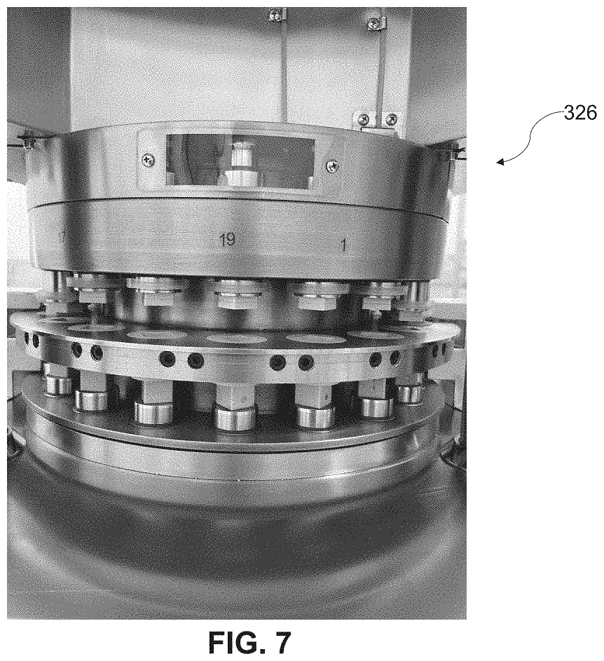

The present invention also provides a method of manufacturing or creating the all-in-one beverage serving 400. The method includes numerous process steps, such as: forming the mixture 102 of FIG. 1 of the predetermined amount of the panela 104, the predetermined amount of the active ingredient 106, optionally the predetermined amount of the functional component 108, and optionally the predetermined amount of the flavoring component 110. The method then includes placing the mixture 102 into the mold 300 and compressing the mixture 102 to form a solid tablet (e.g., the all-in-one beverage serving 400). In examples, the mixture 102 is compressed in the mold 300 using a mechanical action, a hydraulic action, or a pneumatic action. As shown in FIG. 7, machinery 326 may be used to compress the mixture 102 to form the solid tablet (e.g., the all-in-one beverage serving 400). Specifically, the mold 300 may be used with a table press machine (e.g., a machine used in a production line to make the actual solid tablets (e.g., the all-in-one beverage servings 100). In other examples, other machinery known to those having ordinary skill in the art may be used.

In forming the solid tablet (e.g., the all-in-one beverage serving 400), the pulverized panela 104 becomes the agglutinant, so that when the mixture 102 is placed into the mold 300, the panela 104 is compacted by the mechanical, the hydraulic, or the pneumatic action to cause the tablet to bind to the solid state. Specifically, FIG. 9 depicts solid tablets (e.g., the all-in-one beverage servings 400) having differing concentrations of the panela 104 in relation to other ingredients/components.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method of manufacturing an all-in-one beverage serving, the method comprising:
forming a mixture of about panela and an active ingredient;
placing the mixture into a mold; and
compressing the mixture to form a solid tablet.

2. The method of claim 1, wherein the active ingredient is selected from the group consisting of: a beverage material, a nutritional supplement, and a vitamin.

3. The method of claim 1, wherein the active ingredient is a beverage material selected from the group consisting of: coffee, tea, and cocoa.

4. The method of claim 1, wherein the active ingredient is freeze-dried coffee.

5. The method of claim 1, wherein the mixture further comprises a functional component.

6. The method of claim 5, wherein the functional component is selected from the group consisting of: a cannabidiol (CBD), collagen, a digestive enzyme, a protein, and a supplement.

7. The method of claim 1, wherein the mixture is compressed in the mold using a mechanical action, a hydraulic action, or a pneumatic action.

8. The method of claim 1, wherein a shape of the mold is selected from the group consisting of: a circular shape, an oval shape, a rectangular shape, a square shape, a triangular shape, a quadrilateral shape, a pentagonal shape, a hexagonal shape, a heptagonal shape, an octagonal shape, a nonagonal shape, and a decagonal shape such that the mold forms the solid tablet into the shape of the mold.

9. A method of manufacturing an all-in-one beverage serving, the method comprising:
forming a mixture of panela, an active ingredient, and a flavoring component;
placing the mixture into a mold; and
compressing the mixture to form a solid tablet.

10. The method of claim 9, wherein the active ingredient is a beverage material.

11. The method of claim 10, wherein the beverage material is selected from the group consisting of: coffee, tea, and cocoa.

12. The method of claim 9, wherein the mixture further comprises a functional component, and wherein the functional component is selected from the group consisting of: a cannabidiol (CBD), collagen, a digestive enzyme, a protein, and a supplement.

13. The method of claim 9, wherein the active ingredient is freeze-dried coffee.

14. The method of claim 9, wherein the mixture is compressed in the mold using a mechanical action, a hydraulic action, or a pneumatic action.

15. The method of claim 9, wherein the flavoring component is a natural flavoring component or an artificial flavoring component.

16. The method of claim 15, wherein the flavoring component is selected from the group consisting of: a vanilla flavoring component, a caramel flavoring component, a hazelnut flavoring component, a citrus flavoring component, a cinnamon flavoring component, a cappuccino flavoring component, an amaretto flavoring component, a mocha flavoring component, a cocoa flavoring component, a cardamom flavoring component, a maple syrup flavoring component, a honey flavoring component, a pumpkin flavoring component, a ginger flavoring component, a blueberry flavoring component, a chai flavoring component, a chamomile flavoring component, a cranberry flavoring component, an echinacea flavoring component, an apple flavoring component, an elderberry flavoring component, a hibiscus flavoring component, a lemon flavoring component, a lemongrass flavoring component, a mango flavoring component, a mint flavoring component, an orange flavoring component, a peach flavoring component, an almond flavoring component, a pomegranate flavoring component, a berry flavoring component, a raspberry flavoring component, a strawberry flavoring component, and a turmeric flavoring component.

17. The method of claim 9, wherein a shape of the mold is selected from the group consisting of: a circular shape, an oval shape, a rectangular shape, a square shape, a triangular shape, a quadrilateral shape, a pentagonal shape, a hexagonal shape, a heptagonal shape, an octagonal shape, a nonagonal shape, and a decagonal shape such that the mold forms the solid tablet into the shape of the mold.

18. An all-in-one beverage serving comprising:
a predetermined amount of panela;
a predetermined amount of a functional component; and
a predetermined amount of an active ingredient.

19. The all-in-one beverage serving of claim 18, wherein the functional component is selected from the group consisting of: a cannabidiol (CBD), collagen, a digestive enzyme, a protein, and a supplement.

20. The all-in-one beverage serving of claim 18, wherein the active ingredient is selected from the group consisting of: a beverage material, a nutritional supplement, and a vitamin.

21. The all-in-one beverage serving of claim 18, wherein the active ingredient is the beverage material, and wherein the beverage material is selected from the group consisting of: coffee, tea, and cocoa.

22. The all-in-one beverage serving of claim 18, further comprising:
a flavoring component.

23. The all-in-one beverage serving of claim 22, wherein the flavoring component is a natural flavoring component or an artificial flavoring component.
